(19) United States
(12) Patent Application Publication
(10) Pub. No.: US 2001/0028234 A1
(43) Pub. Date: Oct. 11, 2001

(54) Windshield wiper automatic control

(76) Inventor: Timothy Almondo Banhidy, Garden Grove, CA (US)

Correspondence Address: Tim Banhidy, 12091 Faye Ave., Garden Grove, CA, 92840, US

(21) Appl. No.: 09/849,899

(22) Filed: May 7, 2001

Related U.S. Application Data
(63) Continuation-in-part of application No. 09/277,905, filed on Mar. 29, 1999.

(51) Int. Cl. H02P 1/04; H02P 3/00; G05B 5/00; H02P 7/00; H02H 7/08

(52) U.S. Cl. 318/483

(57) ABSTRACT

An automatic control system to automatically adjust the speed of windshield wiper blades. This system includes means effective to generate a signal that measures the amount of liquid on the windshield, means to determine the rate of accumulation of liquid on the windshield, means responsive to this signal to automatically vary the speed of the electric motor driven windshield wiper, and means to incorporate the automatic control system into an existing vehicle wiper control system.

### CROSS-REFERENCE TO RELATED APPLICATIONS Ser. No. 09/277905

### STATEMENT REGARDING FEDERALLY SPONSORED RESEARCH OR DEVELOPMENT

Not Applicable

### REFERENCE TO A MICROFICHE APPENDIX

Not Applicable

### BACKGROUND OF THE INVENTION

1. Field of the Invention

The present invention relates to the field of automotive vehicle accessories, particularly controls for windshield washers and particularly to such controls that control the speed of the windshield wiper blades. Most particularly, the present invention has for its objective an automatic windshield wiper control system, variable as a function of the quantity of liquid on the windshield, or as a function of the rate of accumulation of liquid on the windshield.

2. Prior Art

With present day conventional windshield wiper systems, the speed of the windshield wiper blades is controlled by manual input from the operator of the vehicle. Generally there are several options that the operator of the vehicle has to choose from. An intermittent setting that has a predetermined or operator controlled time delay between wiper action. A continuous slow speed and a continuous fast speed. The intended purpose of providing the operator of the vehicle the ability to vary the speed of the windshield wiper blades is to allow the speed of the wiper blades to be adjusted to best suite the quantity of liquid on the windshield or the rate that liquid accumulates on the windshield.

However, the quantity of liquid on the windshield and/or the rate that liquid accumulates on the windshield continually changes during the operation of the vehicle. These changes can be caused for example by the change in speed of the vehicle, by driving between storm cells, or by the change in weather conditions. This change in quantity of liquid on the windshield and/or the rate that liquid accumulates on the windshield therefore causes the need for the operator to continuously re-adjust the speed of the windshield wiper blades.

By the use of an automatic windshield wiper control system, automatic adjustment of the speed of the windshield wiper blades is provided to compensate for the changes in the quantity of liquid on the windshield and/or the rate that liquid accumulates on the windshield. This automatic adjustment replaces the need for the operator to continuously re-adjust the speed of the windshield wiper blades.

One of the objectives of the present invention is to provide means to incorporate the automatic control system into an existing vehicle wiper control system. This objective does not address the incorporation of the automatic wiper control system in order to minimize impacts to the vehicle wire harnesses and switches. Rather it provides for incorporation into the vehicle to allow for ease of installation and to work with virtually any vehicle wiper control system and wire harnesses. This objective allows for incorporation of the automatic control system as an after marked product.

A related objective of the present invention is to incorporate into the control circuitry or algorithm the function to maintain a constant relationship between the liquid quantity sensor placement and the motor. This objective eliminates the physical variables of the placement of the liquid quantity sensor and of the motor and also allows for incorporation of the automatic control system as an after marked product.

Much of the prior art uses optical sensors as the means for measuring the precipitation on the windshield. One draw back on using optical sensors is the difficulty in measuring a large enough sample area of the windshield. Some inventions have incorporated multiple sets of sensors with complicated controllers. This however can be costly since infrared diodes and photo detectors are relatively expensive. Other inventions use complicated sensor drivers and control systems in an attempt to obtain a large enough sample of the windshield area.

One of the objectives of the present invention is to provide means to connect a minimum number of infrared diodes and photo detectors to a panel of fiber optic filaments or to a light guide to allow for the direct measurement of the precipitation on the windshield at a relatively low cost.

In the use of optical sensors by much of the prior art as the means for measuring the precipitation on the windshield, the optical components have been configured at an angle so that the light directed towards the outside edge of the windshield from the inside will result in an angle at the outside edge of the windshield at the angle of total internal reflection when moisture is not present and less than the angle of total internal reflection when moisture is present. This configuration however gives a non-linear relationship between the reflected light and the amount of moisture on the windshield.

One of the objectives of the present invention is to configure the optical components at an angle so that the light directed towards the outside edge of the windshield from the inside will result in an angle at the outside edge of the windshield at less than the angle of total internal reflection when moisture is or is not present. This configuration gives a linear relationship between the reflected light and the amount of moisture on the windshield.

All prior art uses some form of a threshold to determine when to make adjustments to the speed of the windshield wipers. The prior art however does not make a differentiation between the thresholds used to transition between different speeds. Without a differentiation, constant and annoying speed changes could occur when the precipitation varies slightly across the threshold.

One of the objectives of the present invention is to provide a differentiation between the threshold used to transition from a discontinuous mode to a continuous mode and the threshold used to transition back from the continuous mode to the discontinuous mode or between the threshold used to transition from a lower speed to a higher speed and the threshold used to transition back from the higher speed to the lower speed to avoid constant and annoying speed changes with small variations in the precipitation level.

Much of the prior art employs some type of means to prevent inadvertent operation of the windshield wipers when the moisture sensor is activated by influences other than precipitation. One example given is when the vehicle is going through a car wash.

One of the objectives of the present invention is to provide an alternative means to prevent inadvertent operation of the windshield wipers when the moisture sensor is activated by influences other than precipitation. This is done by periodically cycling the wipers, in the event that moisture is not present, as an indication to the driver that the automatic windshield wiper control system is still functioning thereby causing the operator to turn the system off.

All prior art uses some method of determining the rate of precipitation based on the signals from the moisture sensors.

One of the objectives of the present invention is to provide an alternative means to determine the rate of precipitation. This alternative means compares the time for the moisture sensor to reach an adjustable threshold within a predetermined time.

### BRIEF SUMMARY OF THE INVENTION

It comprises, in combination, means effective to generate a signal that measures the amount of liquid on the windshield, means to determine the rate of accumulation of liquid on the windshield and means responsive to this signal to vary the speed, including both discontinuous and continuous windshield wiper blade operations, of the electric motor driven windshield wiper so as to continuously and automatically adjustment the speed of the windshield wiper blades in order to compensate for the changes in quantity of liquid on the windshield and/or the rate that liquid accumulates on the windshield, means to differentiate between the threshold used to transition from a discontinuous mode to a continuous mode and the threshold used to transition back from the continuous mode to the discontinuous mode, means to differentiate between the threshold used to transition from a lower speed to a higher speed and the threshold used to transition back from the higher speed to the lower speed, means to prevent inadvertent operation of the windshield wipers when the liquid quantity sensor is activated by influences other than precipitation, means to incorporate the automatic control system into an existing vehicle wiper control system, means to provide a linear signal from the liquid quantity sensor relative to the amount of moisture on the windshield.

In addition, since a direct measurement of the rate of accumulation of liquid on the windshield will have some inherent hysteresis, especially in regards to the change in velocity of the vehicle, it may include means effective to generate a vehicle speed signal and means responsive to the vehicle speed signal to vary the speed of the electric motor driven windshield wiper during periods of a minimum predetermined change in the rate of acceleration/deceleration.

### BRIEF DESCRIPTION OF THE SEVERAL VIEWS OF THE DRAWING

FIG. 1 is a perspective view illustrating one application in which the windshield wiper automatic control system may be advantageously employed;

FIG. 2 is a block diagram of a control system according to the invention for use on the vehicle of FIG. 1.

FIG. 3 is a circuit schematic of a control system according to the invention for use on the vehicle of FIG. 1.

FIG. 4 is a circuit schematic of a control circuitry according to the invention for use on the circuit of FIG. 3.

FIG. 5 is a block diagram of a liquid quantity sensor according to the invention for use on the vehicle of FIG. 1.

FIG. 6 is a topographical view of a fiber optic panel according to the invention for use on the circuit of FIG. 5.

FIG. 7 is a cross sectional view of a fiber optic panel according to the invention for use on the circuit of FIG. 5.

### DETAILED DESCRIPTION OF THE INVENTION

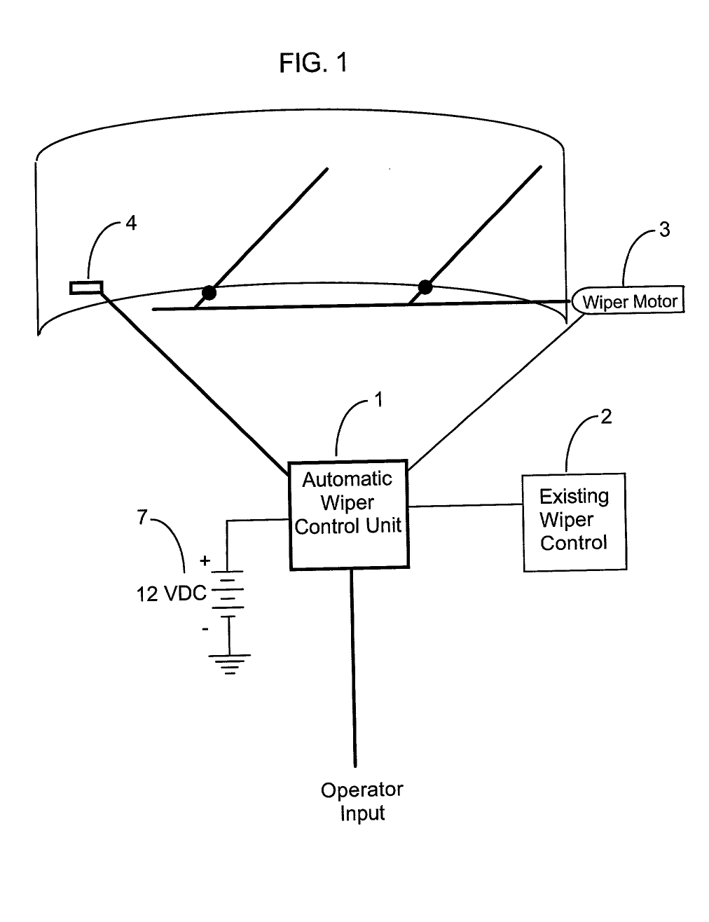

FIG. 1 depicts the use of the automatic windshield wiper control system of the present invention. As mentioned previously, the change in quantity of liquid on the windshield and/or the rate that liquid accumulates on the windshield causes the need for the operator of the vehicle to continuously re-adjust the speed of the windshield wiper blades. As depicted in FIG. 1 such re-adjustments by the operator is not necessary when the present invention is employed.

The invention will be better understood from the following description, which relates to preferred embodiments, given by way of non-limitating examples and explained with reference to the accompanying schematic drawings, in which:

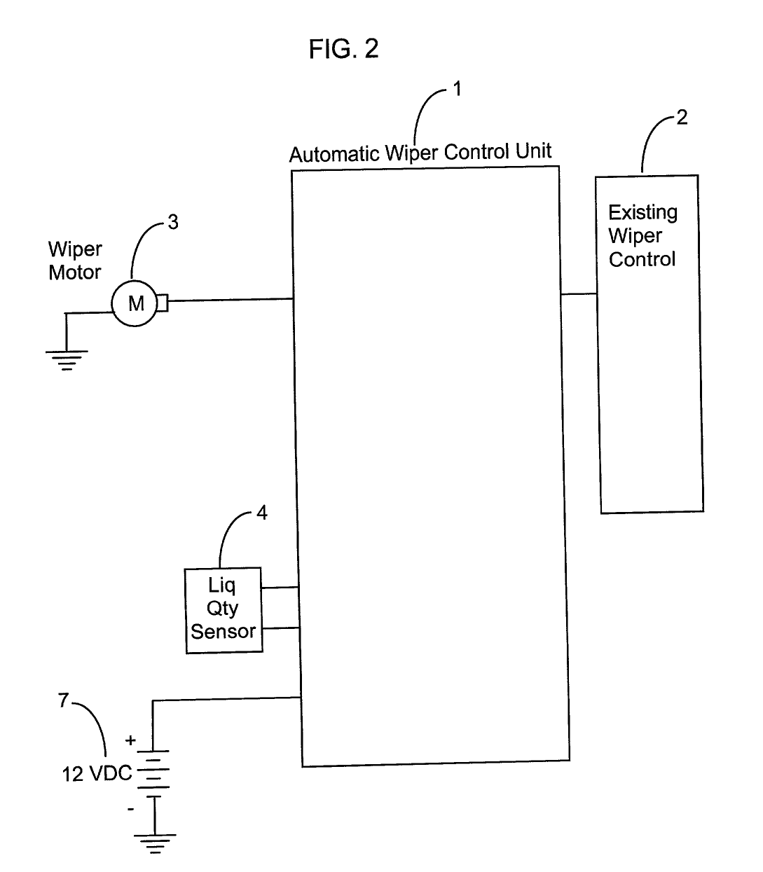

According to the invention and as shown more particularly, by way of example, in FIG. 1 and FIG. 2 of the accompanying drawings, the Automatic Wiper Control Unit 1 is installed to interface with the existing Wiper Control 2 of the vehicle and the existing Wiper Motor 3 of the vehicle.

Prior to the addition of the Automatic Wiper Control Unit 1, 12 VDC power 7 is fed directly to the existing Wiper Control 2. Also, the existing Wiper Control 2 interfaces directly with the Wiper Motor 3.

After the addition of the Automatic Wiper Control Unit 1, 12 VDC power 7 and the interface with the Wiper Motor 3 are routed to the existing Wiper Control 2 through the Automatic Wiper Control Unit 1.

According to a characteristic of the invention, an electronic Liquid Quantity Sensor 4 interfaces with the Automatic Wiper Control Unit 1.

According to another characteristic of the invention, the Automatic Wiper Control Unit 1 accepts inputs from the operator of the vehicle so that it can be adjusted to best suit the specific preferences of a particular vehicle operator.

According to a modified form of the invention, the Automatic Wiper Control Unit 1 can accept input of the speed of the vehicle to be used in the calculation of the quantity of liquid on the windshield.

According to another modified embodiment of the invention, the Liquid Quantity Sensor 4 could be in the form of a mechanical or electronic sensor.

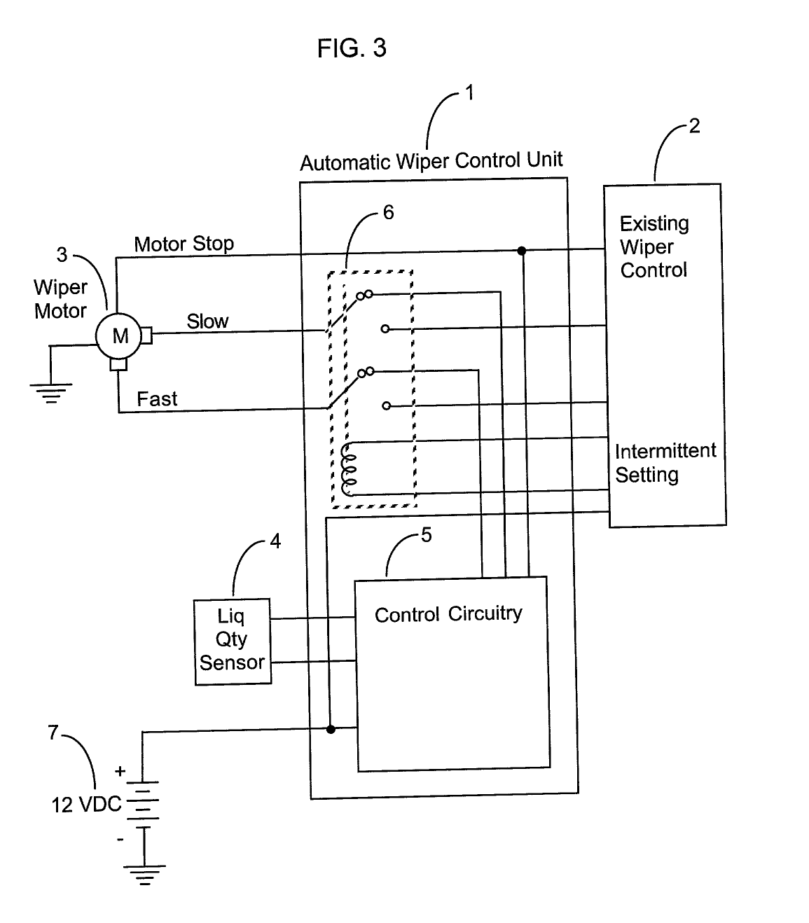

By way of example, the schematic showing the detailed interface between the Automatic Wiper Control Unit 1 and the existing Wiper Control 2 of the vehicle is shown in FIG. 3 of the accompanying drawings. The Automatic Wiper Control Unit 1 is installed in-between the circuit that interfaces between the Wiper Motor 3 and the existing Wiper Control 2. The Automatic Wiper Control Unit 1 is also installed in-between the power 7 and the input to the existing Wiper Control 2. As shown in FIG. 3, Relay 6 of the Automatic Wiper Control Unit 1 switches control of the Wiper Motor 3 between the Control Circuitry 5 of the Automatic Wiper Control Unit 1 and the existing Wiper Control 2. As mentioned previously, there are generally several speeds of the Wiper Motor 3 that the operator of the vehicle has to choose from. In the case of the example shown in FIG. 3, the intermittent setting of the existing Wiper Control 2 is routed to the Automatic Wiper Control Unit to operate the Relay 6. In the example shown in FIG.3, the relay 6 as activated/deactivated by the intermittent setting of the existing Wiper Control 2 will allow normal operation of the existing Wiper Control 2 when the existing Wiper Control 2 is in any position other than the intermittent position. When the existing Wiper Control 2 is in the intermittent position, relay 6 re-routs control of the Wiper Motor 3 to the Control Circuitry 5 of the Automatic Wiper Control Unit 1.

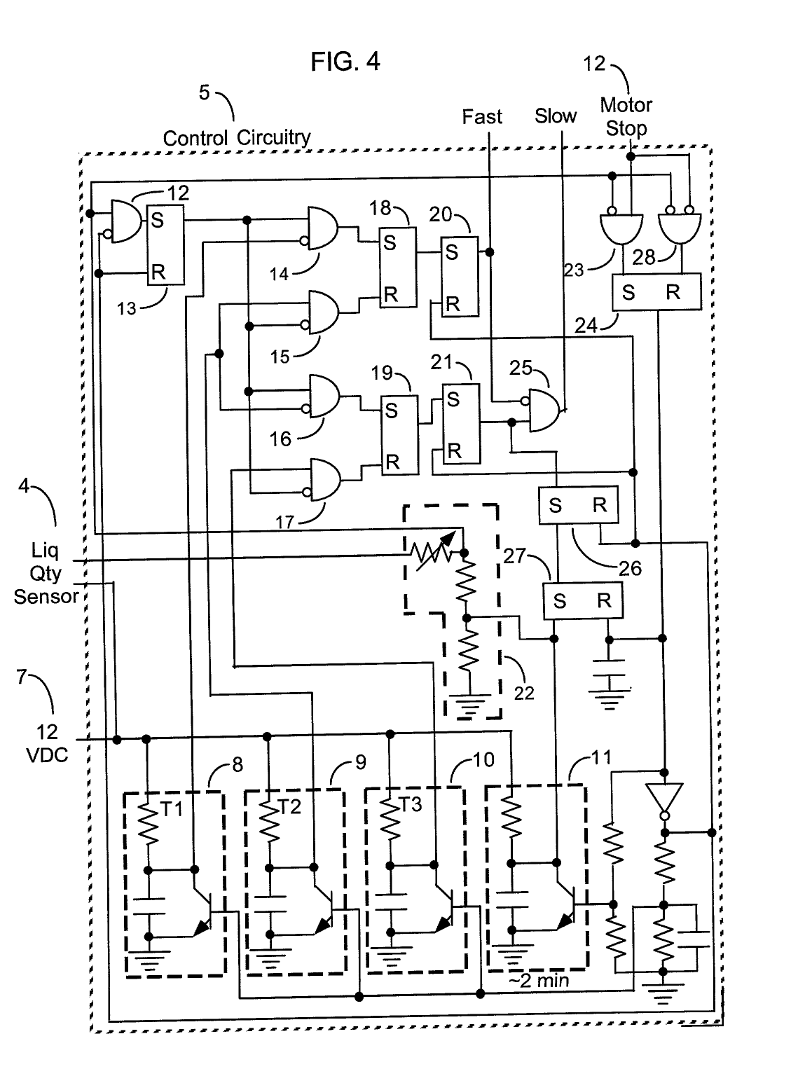

By way of example, the schematic showing the details of the Control Circuitry 5 of the Automatic Wiper Control Unit 1 is shown in FIG. 4 of the accompanying drawings. The explanation of the Control Circuitry 5 will consist of two parts. The first part will discuss the individual components/circuits of the Control Circuitry 5, their function, and the reasoning behind the particular function. The second part will discuss the scenario of the operation of the Control Circuitry 5.

As the Wiper Motor 3 reaches the start/stop position it provides a Motor Stop 12 signal. This Motor Stop 12 signal is routed to the Control Circuitry 5. The Liquid Quantity Sensor 4 is also routed to the Control Circuitry 5. Since the relationship between the function of the Motor Stop 12 signal and the Liquid Quantity Sensor 4 is a mechanical relationship which varies depending on the different motor characteristics and the exact placement of the Liquid Quantity Sensor 4 on the windshield, one of the functions of the Control Circuitry 5 is to eliminate this variation. As shown in FIG. 4 of the accompanying drawings the Motor Stop 12 signal is controlled by the two AND Gates 23 and 28 along with Latch 24. This circuitry ensures that the Motor Stop 12 signal as internally used by the Control Circuitry 5 only changes state when the Liquid Quantity Sensor 4 has been reset (i.e. the windshield has just been cleaned). Furthermore, the Liquid Quantity Sensor 4 is controlled by the single AND Gate 12 and the Latch 13. This circuitry ensures that the Liquid Quantity Sensor 4 as internally used by Comparitors 14, 15, 16 and 17 will always be reset whenever the modified Motor Stop 12 signal indicates that the motor is in the “stop” position. It also ensures that the Liquid Quantity Sensor 4 as internally used by Comparitors 14, 15, 16 and 17 will not be reset until the modified Motor Stop 12 signal is in the “stop” position. The last circuit required to eliminate the variation between the Liquid Quantity Sensor 4 and the Motor Stop 12 signal is Latch 27. One characteristics of the Control Circuitry 5 as shown in the example, is that if the motor is in the “stop” position and has not been previously commanded by the Control Circuitry 5 to operate in a continuous state, the Control Circuitry 5 will command the Wiper Motor 3 to begin one cycle of operation when the Liquid Quantity Sensor 4 has reached the preset limit as determined by Circuitry 22. Since this function must be active when the motor has stopped, it cannot benefit by the use of the modified Liquid Quantity Sensor 4 as discussed above and must use the real input from the Liquid Quantity Sensor 4. Latch 27 is therefore required in order to maintain the state of the circuitry 22 once the Liquid Quantity Sensor 4 has reached the preset limit until the Wiper Motor 3 is not in the “stop” position. The combined function of these three circuits ensures that regardless of the exact placement of the Liquid Quantity Sensor 4 on the windshield and the exact characteristics of the Wiper Motor 3, the relationship between the Motor Stop 12 signal and the Liquid Quantity Sensor 4 as used internal to the Control Circuitry 5 remains constant.

Circuits 8, 9, 10, and 11 are timer circuits. Timer Circuits 8, 9, and 10 are used by Comparitors 14, 15, 16, and 17 as time references to be compared with the modified Liquid Quantity Sensor 4 to determine the rate that liquid is collecting on the windshield. Timer Circuit 11 is set to ˜2 minutes and is needed so that in the event that the collection of liquid on the windshield stops, the wipers will continue to intermittently operate as a reminder to the operator of the vehicle to turn the windshield wiper system off. By positively turning the windshield wiper system off when not required, inadvertent operation during times when the windshield wipers are not required is prevented.

Note that the modified Motor Stop 12 signal as discussed above is used to reset the Timer Circuits 8, 9, 10, and 11. Also note that the Timer Circuits 8, 9, and 10 are reset when the Wiper Motor 3 reaches the “stop” position and the Timer Circuit 11 is reset when the Wiper Motor 3 is not in the “stop” position.

Latches 18 and 19 are required to add some hysteresis into the design of the Control Circuitry 5. Both of these Latches are reset at a lower rate of liquid accumulation on the windshield, as determined by Comparitors 14, 15, 16, and 17, then the rate required to set them. The importance of this hysteresis is to ensure that speed changes of the Wiper Motor 3 only occur when there are relatively large changes in the rate that liquid accumulates on the windshield. Without this hysteresis, constant and annoying speed changes could occur.

Latches 20 and 21 are required in the event that the Comparitors 14, 15, 16 and 17 determine continuous operation of the Wiper Motor 3 is no longer required during mid travel of the wiper blade. In this instant, Latches 20 and 21 continue to deliver power to the Wiper Motor 3 until the Wiper Motor 3 has reached the “stop” position.

Latch 26 is required because as soon as the Wiper Motor 3 begins to operate as a result of Circuit 22 or Timer Circuit 11, Circuit 22 and Timer Circuit 11 will be reset. In this instant, Latch 26 continues to deliver power to the Wiper Motor 3 until the Wiper Motor 3 has reached the “stop” position.

The last component to be discussed is the AND Gate 25. This is required so that the requirement to operate the Wiper Motor 3 fast overrides the requirement to operate the Wiper Motor 3 slow.

The discussion of the scenario of the operation of the Control Circuitry 5 will start at the point that, Relay 6 (see FIG. 3) of the Automatic Wiper Control Unit 1 switches control of the Wiper Motor 3 to the Control Circuitry 5 of the Automatic Wiper Control Unit 1. At this point the first cycle of the Wiper Motor 3 will begin when either one of two things happen. Either when ˜2 minutes has transpired since power was applied to the Automatic Wiper Control Unit 1 as determined by the Timer Circuit 11, or when the Liquid Quantity Sensor 4 has reached the preset limit as determined by Circuit 22.

If ˜2 minutes has not transpired since power was applied to the Automatic Wiper Control Unit 1 and if the Liquid Quantity Sensor 4 reaches the preset limit prior to ˜2 minutes transpiring, Circuit 22 sends a signal to and sets Latch 27. Latch 27 in turn sends a signal to and sets Latch 26. Latch 26 sends a signal to AND Gate 25, which sends power to the Wiper Motor 3 to run the motor slow. As soon as the wiper cleans the windshield on the up stroke, the Liquid Quantity Sensor 4 will be sensing no liquid on the windshield, circuit 22 will be de-energized and Latch 27 will be reset when the modified Motor Stop 12 signal is not in the stop position. At this point Latch 26 remains set and continues to send a signal to AND Gate 25. At this point even if the Liquid Quantity Sensor 4 reaches the preset limit prior to the Wiper Motor 3 returning to the start position the Liquid Quantity Sensor 4 will once again sense no liquid on the windshield due to the down stroke of the wiper blade, circuit 22 would be de-energized and Latch 27 would be reset. On the down stroke however, Latch 26 will also be reset by the modified Motor Stop 12 signal and, assuming Latches 18 and 19 are not set, the motor will stop. In other words, the motor will run one cycle.

If ˜2 minutes has transpired since power was applied to the Automatic Wiper Control Unit 1, Timer Circuit 11 sends a signal to and sets Latch 27. Latch 27 in turn sends a signal to and sets Latch 26. Latch 26 sends a signal to AND Gate 25 that sends power to the Wiper Motor 3 to run the motor slow. As soon as the modified Motor Stop 12 signal is not in the stop position, the Timer Circuit 11 and Latch 27 will be reset. At this point Latch 26 remains set and continues to send a signal to AND Gate 25. When the Wiper Motor 3 returns to the start position, Latch 26 will be reset by the modified Motor Stop 12 signal and, assuming Latches 18 and 19 are not set, the motor will stop. In other words, the motor will run one cycle.

As discussed above, from the point that the Liquid Quantity Sensor 4 reaches the preset limit, or after ˜2 minutes whichever comes first, power will be sent to the Wiper Motor 3 to run the motor slow. As soon as the wiper cleans the windshield during the up stroke the Liquid Quantity Sensor 4 will be sensing no liquid on the windshield and when the modified Motor Stop 12 signal is not in the stop position, Latch 27 will be reset. For ease of discussion, this point will be defined as the “point 0”. Note that from this “point 0” as soon as the motor returns to the start position, Latch 26 will be reset. From this “point 0”, Timer Circuits 8, 9, and 10 begin to count and Comparitors 14, 15, 16, and 17 begin to compare the modified Liquid Quantity Sensor 4 with the Timer Circuits 8, 9, and 10. If the modified Liquid Quantity Sensor 4 reaches the preset limit within time T1 as determined by the time constant of the Timer Circuit 8, the Comparitor 14 sets Latch 18. Latch 18 sets Latch 20 which sends power to the Wiper Motor 3 to run the motor fast. Once Latch 18 has been set, it will continue to set Latch 20 which sends power to the Wiper Motor 3 to run the motor fast until it has been reset. Resetting of Latch 18 occurs when from the “point 0” of every cycle, Comparator 15 determines that the modified Liquid Quantity Sensor 4 has not reached the preset limit within time T2 as determined by the time constant of the Timer Circuit 9. Note that T2 is greater than T1.

Note that in the case when the Wiper Motor 3 is in a continuous run mode, the modified Liquid Quantity Sensor 4 and the Timer Circuits 8, 9, and 10 will be reset at the beginning of every cycle of the Wiper Motor 3.

Returning to the “point 0”, if the modified Liquid Quantity Sensor 4 reaches the preset limit within time T2 as determined by the time constant of the Timer Circuit 9, the Comparator 16 sets Latch 19. The output of Latch 19 sets Latch 21 which sends power to the Wiper Motor 3 to run the motor slow if AND Gate 25 has not been inhibited by Latch 20. Once Latch 19 has been set it will continue to set Latch 21 which sends power to the Wiper Motor 3 to run the motor slow until it has been reset. Resetting of Latch 19 occurs when from the “point 0” of every cycle, Comparator 17 determines that the modified Liquid Quantity Sensor 4 has not reached the preset limit within time T3 as determined by the time constant of the Timer Circuit 10. Note that T3 is greater than T2.

If the Wiper Motor 3 is running fast, Latches 18, 19, 20, and 21 will be set as discussed above. If the motor is running fast and then the modified Liquid Quantity Sensor 4 reaches the preset limit between time T2 as determined by the time constant of the Timer Circuit 9 and time T3 as determined by the time constant of the Timer Circuit 10, Latch 18 will be reset. Also, at the beginning of the Wiper Motor 3 cycle, Latch 20 will be reset thus removing the inhibit from AND Gate 25. At this point Latches 19 and 20 remain set, the inhibit is removed from AND Gate 25 and the AND Gate 25 will send power to the Wiper Motor 3 to run the motor slow.

If the Wiper Motor 3 is running slow, Latches 18, and 19 are not set and Latches, 20, and 21 will be set as discussed above. If the motor is running slow and then the Liquid Quantity Sensor 4 reaches the preset limit time T 1 as determined by the time constant of the Timer Circuit 8, the Comparator 14 sets Latch 18. Latch 18 sets Latch 20 which sends power to the Wiper Motor 3 to run the motor fast and at the same time inhibits the AND Gate 25 and the Wiper Motor will run fast.

If the Wiper Motor 3 is running either fast or slow, and then the Liquid Quantity Sensor 4 does not reach the preset limit within time T3 as determined by the time constant of the Timer Circuit 10, then Latches 19 and/or 18 will be reset. At this point Latches 21 and/or 20 remain set and do not get reset until the beginning of the Wiper Motor 3 cycle thus continuing the delivery of power to the Wiper Motor 3 until the Wiper Motor 3 has reached the “stop” position. Once the Wiper Motor 3 has reached the “stop” position Latches 21 and/or 20 gets reset and the motor stops.

According to a modified form of the invention, the algorithm of the logic of the automatic control system as defined by the Control Circuitry 5 can be incorporated into a data processor based system.

According to another modified embodiment of the invention, the algorithm of the logic of the automatic control system as defined by the Control Circuitry 5 can be incorporated into an existing data processing system of the vehicle.

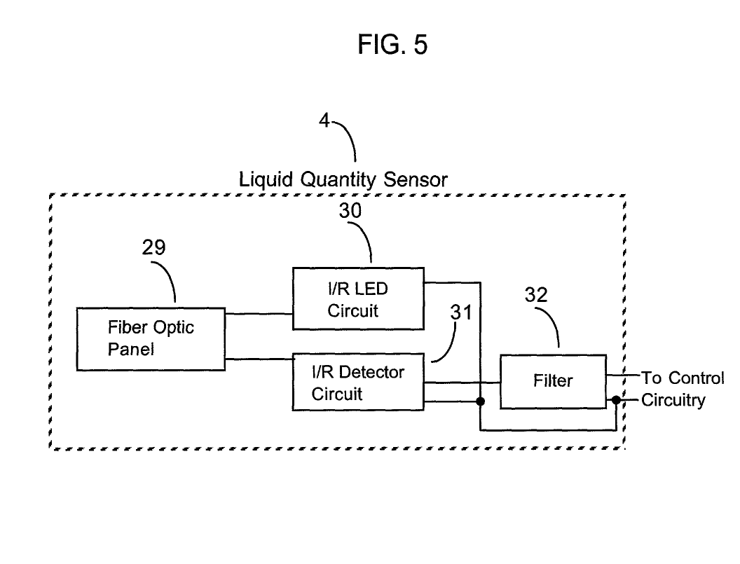

By way of example, the schematic showing the details of the Liquid Quantity Sensor 4 of the Automatic Wiper Control Unit 1 is shown in FIG. 5 of the accompanying drawings. An Infrared LED Circuit 30 is connected to a Fiber Optic Panel 29. The Fiber Optic Panel 29 is also connected to an Infrared Detector Circuit 3 1. The output of the Infrared Detector Circuit 31 is fed through a Filter 32.

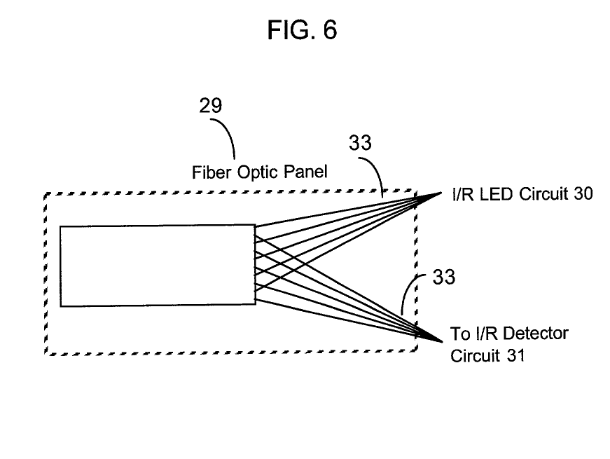

By way of example, the schematic showing the details of the Fiber Optic Panel 29 of the Automatic Wiper Control Unit 1 is shown in FIG. 6 of the accompanying drawings. This figure shows that some of the fiber optic filaments 33 of the Fiber Optic Panel 29 have been connected to the Infrared LED Circuit 30 and some of the fiber optic filaments 33 of the Fiber Optic Panel 29 have been connected to the Infrared Detector Circuit 3 1.

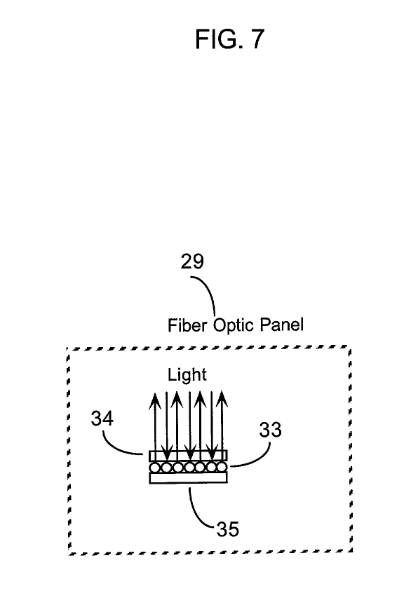

By way of example, the schematic showing the details of the Fiber Optic Panel 29 of the Automatic Wiper Control Unit 1 is further shown in FIG. 7 of the accompanying drawings. As shown, the fiber optic filaments 33 of the Fiber Optic Panel 29 have been configured to radiate and receive light from its sides. Experimentation as shown that light directed towards the outside edge of the windshield from the inside, at an angle that will result in an angle at the outside edge of the windshield of less than the angle of total internal reflection gives a linear relationship between the reflected light and the amount of moisture on the windshield. The Fiber Optic Panel 29 is therefore configured to radiate and receive the reflected light from the windshield at an angle that will result in an angle at the outside edge of the windshield of less than the angle of total internal reflection. An infrared filter 34 is also placed over the fiber optic filaments 33 to reduce the effects of the ambient light. Also a non-reflective cover 35 is placed over the backside of the Fiber Optic Panel 29 to avoid false signals from object behind the Fiber Optic Panel 29.

The infrared light from the Infrared LED Circuit 30 is carried to and radiated over approximately ½ the area of the Fiber Optic Panel 29. The light reflected back to the Fiber Optic Panel 29 from the windshield will be picked up by approximately ½ the area of the Fiber Optic Panel 29 and will deliver the light to the Infrared Detector Circuit 31. The Fiber Optic Panel 29 therefore not only transmits light from the Infrared LED Circuit 30 and to the Infrared Detector Circuit 31, it also effectively integrates the transmission and reception of light over a large area. As moisture accumulates on the windshield in the area over the Fiber Optic Panel 29, less light will be reflected back to the Infrared Detector Circuit 31.

1. An automatic wiper control unit wherein the incorporation of an automatic windshield wiper control system into an existing vehicle includes the installation of the automatic windshield wiper control system to allow it to prevent the existing automobile wiper control system from operating the windshield wiper motor and to cause the new automatic wiper control system to operate the existing automobile wiper motor.

2. An automatic windshield wiper control system as in claim 1, wherein the automatic windshield wiper control system is comprised of:
(A) A control module adapted to be disposed in operative association with the windshield wiper circuitry of a vehicle, said module including:
(i) input and output means operatively connected to said windshield wiper circuitry and liquid quantity sensor and adapted to receive and deliver signals and power therefrom and thereto; and
(ii) a logic center composed of discrete electronic components in operative association with said windshield wiper circuitry of a vehicle to decode the received vehicle windshield wiper control and liquid quantity sensor signals and: deliver power to windshield wiper motor of a vehicle in response to the signal from the liquid quantity sensor and/or signals from the circuitry of a vehicle; and deliver power to said windshield wiper motor of a vehicle periodically in the absence of liquid on the windshield.

3. A windshield wiper automatic control system as in claim 2, wherein the algorithm of the logic center of the control module is incorporated within a data processor.

4. A moisture sensor wherein optical components of a moisture sensor are configured at an angle so that the light directed towards the outside edge of the windshield from the inside will result in an angle at the outside edge of the windshield at less than the angle of total internal reflection when moisture is or is not present.

5. An optical moisture sensor as in claim 4, wherein the optical moisture sensor is incorporated into a windshield wiper automatic control system comprising:
(A) A control module adapted to be disposed in operative association with the windshield wiper circuitry of a vehicle, said module including:
(i) input and output means operatively connected to said windshield wiper circuitry and liquid quantity sensor and adapted to receive and deliver signals and power therefrom and thereto;
(ii) means to transfer control of the windshield wiper motor between said wiper control circuitry of a vehicle and the automatic wiper control circuitry in response to signals from either said wiper control circuitry of a vehicle or directly from the operator of the vehicle; and
(iii) a logic center composed of discrete electronic components in operative association with said windshield wiper circuitry of a vehicle to decode the received vehicle windshield wiper control and liquid quantity sensor signals and: deliver power to windshield wiper motor of a vehicle in response to the signal from the liquid quantity sensor and/or signals from the circuitry of a vehicle; and deliver power to said windshield wiper motor of a vehicle periodically in the absence of liquid on the windshield.

6. A windshield wiper automatic control system as in claim 5, wherein the algorithm of the logic center of the control module is incorporated within a data processor.

7. A moisture sensor wherein a minimum number of infrared sources and infrared detectors are connected to a panel of fiber optic filaments or to a light guide for the measurement of liquid on a clear surface.

8. A light panel or light guide as in claim 7, wherein the light panel or light guide is incorporated into a windshield wiper automatic control system comprising:
(A) A control module adapted to be disposed in operative association with the windshield wiper circuitry of a vehicle, said module including:
(i) input and output means operatively connected to said windshield wiper circuitry and liquid quantity sensor and adapted to receive and deliver signals and power therefrom and thereto;
(ii) means to transfer control of the windshield wiper motor between said wiper control circuitry of a vehicle and the automatic wiper control circuitry in response to signals from either said wiper control circuitry of a vehicle or directly from the operator of the vehicle; and
(iii) a logic center composed of discrete electronic components in operative association with said windshield wiper circuitry of a vehicle to decode the received vehicle windshield wiper control and liquid quantity sensor signals and: deliver power to windshield wiper motor of a vehicle in response to the signal from the liquid quantity sensor and/or signals from the circuitry of a vehicle; and deliver power to said windshield wiper motor of a vehicle periodically in the absence of liquid on the windshield.

9. A windshield wiper automatic control system as in claim 8, wherein the algorithm of the logic center of the control module is incorporated within a data processor.

10. A control algorithm of an automatic windshield wiper control system which includes a differentiation between the threshold used to transition from a lower speed to a higher speed and the threshold used to transition back from the higher speed to the lower speed and/or a differentiation between the threshold used to transition from a discontinuous mode to a continuous mode and the threshold used to transition back from the continuous mode to the discontinuous mode.

11. A control algorithm as in claim 10, wherein the method is incorporated into a windshield wiper automatic control system comprising:
(A) A control module adapted to be disposed in operative association with the windshield wiper circuitry of a vehicle, said module including:
(i) input and output means operatively connected to said windshield wiper circuitry and liquid quantity sensor and adapted to receive and deliver signals and power therefrom and thereto;
(ii) means to transfer control of the windshield wiper motor between said wiper control circuitry of a vehicle and the automatic wiper control circuitry in response to signals from either said wiper control circuitry of a vehicle or directly from the operator of the vehicle; and
(iii) a logic center composed of discrete electronic components in operative association with said windshield wiper circuitry of a vehicle to decode the received vehicle windshield wiper control and liquid quantity sensor signals and: deliver power to windshield wiper motor of a vehicle in response to the signal from the liquid quantity sensor and/or signals from the circuitry of a vehicle; and deliver power to said windshield wiper motor of a vehicle periodically in the absence of liquid on the windshield.

12. A windshield wiper automatic control system as in claim 11, wherein the algorithm of the logic center of the control module is incorporated within a data processor.

13. A control algorithm of an automatic windshield wiper control system which includes delivering power to a windshield wiper motor of a vehicle periodically in the absence of liquid on the windshield.

14. A control algorithm as in claim 13, wherein the method is incorporated into a windshield wiper automatic control system comprising:
(A) A control module adapted to be disposed in operative association with the windshield wiper circuitry of a vehicle, said module including:
(i) input and output means operatively connected to said windshield wiper circuitry and liquid quantity sensor and adapted to receive and deliver signals and power therefrom and thereto;
(ii) means to transfer control of the windshield wiper motor between said wiper control circuitry of a vehicle and the automatic wiper control circuitry in response to signals from either said wiper control circuitry of a vehicle or directly from the operator of the vehicle; and
(iii) a logic center composed of discrete electronic components in operative association with said windshield wiper circuitry of a vehicle to decode the received vehicle windshield wiper control and liquid quantity sensor signals and: deliver power to windshield wiper motor of a vehicle in response to the signal from the liquid quantity sensor and/or signals from the circuitry of a vehicle.

15. A windshield wiper automatic control system as in claim 14, wherein the algorithm of the logic center of the control module is incorporated within a data processor.

16. A control algorithm of an automatic windshield wiper control system which includes the comparison of the time for the liquid quantity sensor to reach an adjustable threshold within a predetermined time.

17. A control algorithm as in claim 16, wherein the method is incorporated into a windshield wiper automatic control system comprising:
(A) A control module adapted to be disposed in operative association with the windshield wiper circuitry of a vehicle, said module including:
(i) input and output means operatively connected to said windshield wiper circuitry and liquid quantity sensor and adapted to receive and deliver signals and power therefrom and thereto;
(ii) means to transfer control of the windshield wiper motor between said wiper control circuitry of a vehicle and the automatic wiper control circuitry in response to signals from either said wiper control circuitry of a vehicle or directly from the operator of the vehicle; and
(iii) a logic center composed of discrete electronic components in operative association with said windshield wiper circuitry of a vehicle to decode the received vehicle windshield wiper control and liquid quantity sensor signals and: deliver power to windshield wiper motor of a vehicle in response to the signal from the liquid quantity sensor and/or signals from the circuitry of a vehicle; and deliver power to said windshield wiper motor of a vehicle periodically in the absence of liquid on the windshield.

18. A windshield wiper automatic control system as in claim 17, wherein the algorithm of the logic center of the control module is incorporated within a data processor.

19. A control algorithm of an automatic windshield wiper control system which includes the function to maintain a constant relationship between the liquid quantity sensor placement and the motor.

20. A control algorithm as in claim 19, wherein the method is incorporated into a windshield wiper automatic control system comprising:
(A) A control module adapted to be disposed in operative association with the windshield wiper circuitry of a vehicle, said module including:
(i) input and output means operatively connected to said windshield wiper circuitry and liquid quantity sensor and adapted to receive and deliver signals and power therefrom and thereto;
(ii) means to transfer control of the windshield wiper motor between said wiper control circuitry of a vehicle and the automatic wiper control circuitry in response to signals from either said wiper control circuitry of a vehicle or directly from the operator of the vehicle; and
(iii) a logic center composed of discrete electronic components in operative association with said windshield wiper circuitry of a vehicle to decode the received vehicle windshield wiper control and liquid quantity sensor signals and: deliver power to windshield wiper motor of a vehicle in response to the signal from the liquid quantity sensor and/or signals from the circuitry of a vehicle; and deliver power to said windshield wiper motor of a vehicle periodically in the absence of liquid on the windshield.

21. A windshield wiper automatic control system as in claim 20, wherein the algorithm of the logic center of the control module is incorporated within a data processor.
